(19) United States
(12) Patent Application Publication
(10) Pub. No.: US 2015/0356516 A1
(43) Pub. Date: Dec. 10, 2015

(54) SYSTEM AND METHOD FOR FACILITATING MEETINGS BETWEEN MULTIPLE PARTICIPANTS

(71) Applicant: G.Y.A Meeter Media Ltd., Tel Aviv (IL)

(72) Inventors: Niv KAGAN, Hod Hasharon (IL); Tamir SCHERZER, Herzliya (IL)

(73) Assignee: G.Y.A Meeter Media Ltd., Tel Aviv (IL)

(21) Appl. No.: 14/735,642

(22) Filed: Jun. 10, 2015

Related U.S. Application Data
(60) Provisional application No. 62/009,956, filed on Jun. 10, 2014.

(51) Int. Cl. G06Q 10/10

(52) U.S. Cl. CPC G06Q 10/1095

(57) ABSTRACT

A method and system for automatically setting a meeting among a plurality of participants are disclosed. The method comprises receiving a request to set a meeting, wherein the request includes a list of the request participants and a duration of the meeting; determining a global availability for each of the requested participants; determining general behavioral availability for each of the requested participants and among the requested participants; determining aggregated behavioral availability among the requested participants; correlating the determined global availability, the aggregated behavioral availability, and the behavioral availability to result with at least one time slot having a higher acceptance probability; and sending a meeting invitation for the at least one time slot.

### CROSS-REFERENCE TO RELATED APPLICATIONS

This application claims the benefit of U.S. provisional application No. 62/009,956 filed on Jun. 10, 2014. This application is herein incorporated by reference.

### TECHNICAL FIELD

The disclosure generally relates to a system and method for facilitating meetings, and more particularly to a system which automatically facilitates most likely available meeting times and venues between multiple participants.

### BACKGROUND

The process of scheduling a meeting between multiple participants is often overly cumbersome. Arriving at a mutually beneficial time and venue typically requires multiple communications between all participants. This process wastes time and resources.

Facilitation of large meetings requires the time and energy of multiple people if performed by conventional methods. Hours are wasted reading through emails and talking on the phone to arrange for a time and place to meet. The meeting coordination can be performed by the participants or dedicated staff. To further complicate matters, once one meeting participant experiences a change in schedule, often the entire meeting facilitation process must be started over from scratch, requiring more time from the participants or dedicated staff.

Current software solutions exist which implement calendar functionality. However, participants in a meeting may not all utilize the same calendar software, particularly in cross-organizational meetings. Multiple calendar solutions exist, such as Outlook® and Google Calendar®. Software interaction between competing solutions is currently difficult and prone to error. In some cases, participants using the same calendar type may not have access to the availability of other participants. For example, a first participant using Outlook® trying to schedule a meeting with a second participant using Google Calendar® may not have any information about the availability of the second user. This wastes further time and resources in facilitating meetings. All of these concerns are further exacerbated as the number of participants increase.

Therefore, it would be advantageous to provide a solution for facilitating meetings between multiple participants by automatically determining meeting times and venues mutually beneficial to all participants across all platforms with minimal user input.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for automatically setting a meeting among a plurality of participants. The method comprises receiving a request to set a meeting, wherein the request includes a list of the request participants and a duration of the meeting; determining a global availability for each of the requested participants; determining general behavioral availability for each of the requested participants and among the requested participants; determining aggregated behavioral availability among the requested participants; correlating the determined global availability, the aggregated behavioral availability, and the behavioral availability to result with at least one time slot having a higher acceptance probability; and sending a meeting invitation for the at least one time slot.

Certain embodiments disclosed herein also include a system for automatically setting a meeting among a plurality of participants. The system comprises a processing unit; and a memory, the memory containing instructions that, when executed by the processing unit, configure the system to: receive a request to set a meeting, wherein the request includes a list of the request participants and a duration of the meeting; determine a global availability for each of the requested participants; determine general behavioral availability for each of the requested participants and among the requested participants; determine aggregated behavioral availability among the requested participants; correlate the determined global availability, the aggregated behavioral availability, and the behavioral availability to result with at least one time slot having a higher acceptance probability; and send a meeting invitation for the at least one time slot.

### BRIEF DESCRIPTION OF THE DRAWINGS

The subject matter that disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a networked meeting facilitation system utilized to describe the disclosed embodiments.

FIG. 2 is a schematic diagram depicting the depicting the logical modules as implemented or realized by a scheduling server and each client device.

FIG. 3 is a schematic diagram depicting an availability matrix computed to determine availability of a participant.

FIG. 4 is a schematic diagram depicting a calendar unification engine.

FIG. 5 is a flowchart depicting a method a method for automatically setting a meeting among multiple participants.

FIG. 6 is a diagram depicting segmentation of availability of a participant per device.

FIG. 7 is a diagram depicting a sub-availability matrix computed to determine availability of a participant.

FIG. 8 is a diagram of a weekly aggregated behavior weight matrix computed to determine availability of a participant.

FIG. 9 is a diagram of a weekly general behavior matrix computed to determine availability of a participant.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein describe a system for facilitating meetings between multiple participants. The system is configured to interface with the calendar software of each participant to derive a probable meeting time and venue. Supporting functionality is provided such as documentation storage, generation of minutes, generation of tasks, and the like.

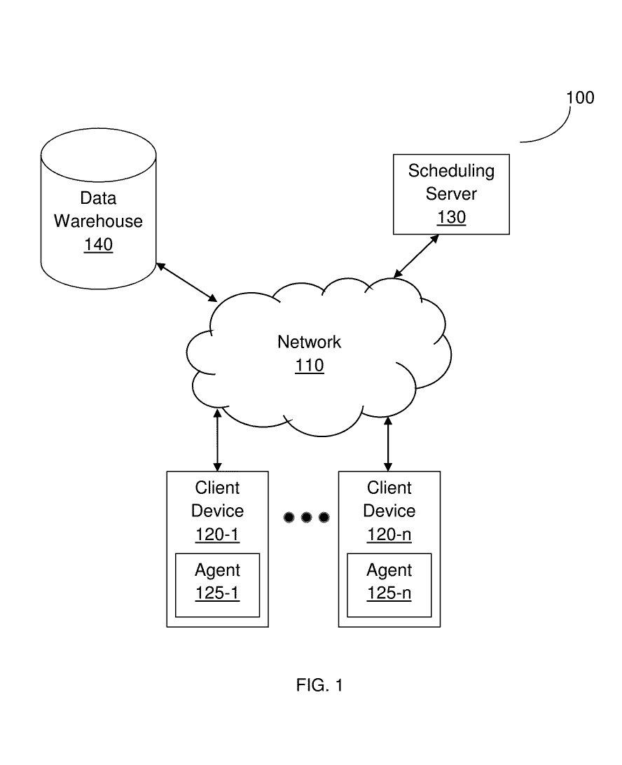

FIG. 1 is an exemplary and non-limiting schematic diagram of a networked system 100 utilized to describe the disclosed embodiments of meetings facilitation. A network 110 is used to communicate between different parts of the system 100. The network 110 may be the Internet, the world-wide-web (WWW), a local area network (LAN), a wide area network (WAN), a metro area network (MAN), and the like. The network 110 may be a cloud-computing infrastructure.

Connected to the network 110 are a plurality of client devices 120-1 through 120-n (collectively referred hereinafter as client devices 120 or individually as a client device 120, merely for simplicity purposes). The client device 120 may be, but is not limited to, a personal computer (PC), a personal digital assistant (PDA), a mobile phone, a smart phone, a tablet computer, a laptop, a wearable computing device, and the like. It should be noted that two client devices 120 are illustrated in FIG. 1 only for the sake of simplicity and without limitation on the generality of the disclosed embodiments.

Further connected to the network 110 is a scheduling server 130 and a data warehouse 140. The data warehouse 140 is configured to store calendar data and data related to the users of the system 100. The data warehouse 140 is further configured to store meeting notes, agendas, tasks, and the like associated with the meeting. In an embodiment, the data warehouse 140 associates meeting notes with relevant participants. In an embodiment, a permission mechanism is implemented by the scheduling server 130 to determine who of the participants can access, edit, and/or share any of the meeting's notes. The permission mechanism further determines the period of time that each authorized participant can access the stored note. In a further embodiment, a participant may be determined by its name and/or role. If identified by a role, any other person from the organization with the same role (or an equivalent role) can access the stored note.

In an embodiment, each client device 120 includes an agent 125 locally installed and executed over the client device 120. Each agent 125 can be implemented as a stand-alone program or, alternatively, can communicate and be integrated with other programs or applications executed in the client device 120. For example, the agent 125 may be realized as a software application (such as a mobile application, a native application, a virtual application, etc.), a plug-in, an add-on, or the like. The plug-in and/or add-on may be added to a web browser of the client device 120, any calendar program installed on the client device (e.g., Outlook®), and the like.

The disclosed embodiments for automatically scheduling a meeting among multiple participants are realized by the server 130 and the agents 125. In an embodiment, a scheduling of a meeting includes determining a time and location of the meeting to the best availability of all the participants.

A user of a client device 120 who wishes to schedule a meeting simply needs to select the meeting's participants. Some of the participants may be designated as required and the others as optional. In response, the server 130 is configured to return a meeting invitation detailing the time and place that all participants (or at least those who are required) can attend. The meeting invitation is sent to all client devices 120 of users participating in the meeting.

To this end, each agent 125 is configured to generate an availability matrix for a user of the client device 120. The availability matrix defines, per each email account of a user, when the user is available for a meeting and is generated respective of scheduled meetings designated in one or more of the user online calendars. The various embodiments for generating the availability matrix are discussed in greater detail below. The generated availability matrix is sent to the server 130 by the respective agent 125, and saved in the data warehouse 140. In an embodiment, an initial availability matrix is generated upon installation of an agent 125 and each generated matrix can be updated from time to time (e.g., every 3 hours), upon initiation or receiving of a meeting request, and/or upon any update performed in the online calendar of the user. It should be noted that availability matrix is generated by each agent 125 regardless if the user requests for a meeting or was invited to participate in a meeting.

According to some embodiments, the scheduling server 130 is configured to analyze availability matrixes as received by each agent 125 to generate a global availability matrix (GAM) that designates the availability of the user across all the client devices 120 and emails (including those that are registered with server 130) of the user. The server 130 is further configured to determine the user's availability respective of the behavioral analysis and collaborative filtering. Based on the analysis, the server 130 is configured to determine a time slot score that would indicate the probability that the respective time slot will be acceptable by all participants. In an embodiment, the score is computed by correlating an availability data among all participants. As a simple example, if a meeting should be scheduled between users of client devices 120-1 and 120-n, the various availably matrixes generated for these users are correlated. The output of the availability correlation process may result in one or more recommendations for a meeting schedule. A meeting invitation may be generated respective of the recommendation with the highest availability probability.

In an embodiment, the scheduling server 130 is further configured to generate, via a communicator module 236, participant communication links, post-scheduling conflict detection, pre-meeting participant location sharing, and pre-meeting participant messaging. The scheduling server 130 may generate a meeting agenda generation widget, including a resource allocator for the requested meeting, and send the widget to a meeting organizer. In an embodiment, one user is designated as the meeting organizer. The meeting organizer may or may not be a participant in the meeting. The meeting organizer may set the priority level of the meeting.

In an embodiment, after scheduling the meeting but before it occurs, the scheduling server 130 is further configured to establish communication links between meeting participants to provide for pre-meeting chats, broadcasts/updates, and meeting related document sharing. In a further embodiment, the scheduling server 130 is configured to establish communication links to documents stored in the data warehouse 140.

The scheduling server 130 is further configured to automatically generate a virtual venue for non-physical or hybrid meetings, including communication links, document storage, meeting recording, and transcription functionality. The scheduling server 130 is further configured to provide for automatic location sharing around the time of the meeting so that participants can estimate the time of each other's arrival to physical meetings. Location data is provided from each client device 120 of each participant.

In an embodiment, after a meeting occurs, the scheduling server 130 is configured to provide a meeting summary generation wizard. The scheduling server 130 is further configured to provide a post-meeting task generation wizard.

It should be noted that the scheduling server 130 typically includes a processing unit (not shown) and a memory (not shown). The processing unit may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may be coupled to the memory. In an embodiment, the memory contains instructions that when executed by the processing unit results in the performance of the methods and processes described herein below. Specifically, the processing unit may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit to perform the various functions described herein.

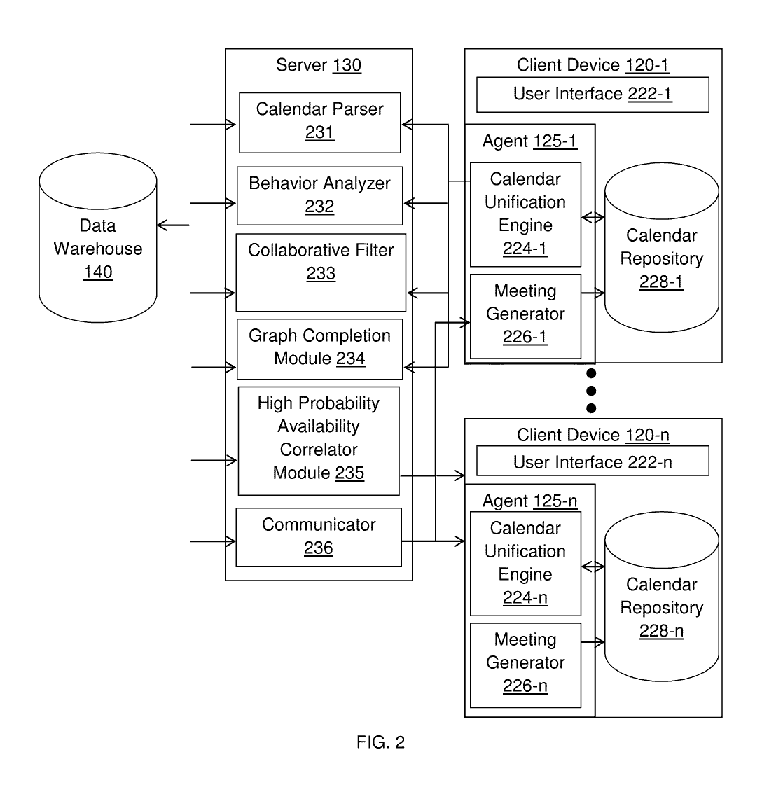

FIG. 2 is an exemplary and non-limiting schematic diagram depicting the logical modules as implemented or realized by the scheduling server 130 and each client device 120 according to one embodiment. The scheduling server 130 includes a calendar parser module 231, an action based behavior analyzer module 232, an action based collaborative filter module 233, a graph completion module 234, a high probability availability correlator module 235, and a communicator module 236.

The calendar parser module 231 is configured to read and parse online calendars. In the context of the disclosed embodiments, online calendars may include any calendar that can be accessed through the client device 120 and associated with a user email account. For example, an online calendar may include, Outlook®, Gmail® calendar, and the like.

The behavior analyzer module 232 and collaborative filter module 233 are configured to use information from the online calendars and additional events to analyze and derive a predictive model of the user and participants related to the user. The graph completion module 234 is configured to model relationships between users and groups. The graph completion module 234 is further configured to obtain information on emails that are not associated with client devices 120 running the agent 125.

When a request for a meeting is received, data is pulled from the data warehouse 140 by the high probability availability correlator module 235. In an embodiment, the pulled data include various availability matrixes computed for the meeting's participants. The high probability availability correlator module 235 outputs optimal recommendations for meetings, which are then presented to the meeting's participants for further action by the communicator module 236.

The scheduling server 130 is further configured to determine best possible meeting times and locations for all meeting participants in the near real-time through a predictive scheduling algorithm. The scheduling server 130 is configured to make these determinations even if participants are dispersed and connected to different scheduling systems.

In an embodiment, the scheduling server 130 continuously profiles and tracks meetings and participants, improving time and location management through a series of algorithms and the collaborative filter module 233. By analyzing all of the non-structured data, the scheduling server 130 is configured to predict, at high probability, the availability of required participants. Determination of scheduling is based on the ability to provide an optimal time and place for multiple participants to meet when considering multiple constraints, such as, but not limited to, a participant's personal availability, a priority level of the meeting, social connections with the other participants of the meeting, meeting frequency, meeting attendance behavior, predictive and collaborative filters, and so on. The priority level is weighted by a total number of participants and time left until the meeting.

The client device 120 comprises a user interface 222, a calendar repository 228, and an agent 125. The user interface 222 may receive inputs from the users, such as meeting requests, acceptance of the meetings, and so on. For example, the user interface 222 may be a touch screen display.

The calendar repository 228 contains all online calendars that belong to and/or can be accessed by a user of the client device 120. Each calendar in the repository 228 is associated with a separate email and may be served by a different provider, such as Gmail®, Outlook®, Yahoo Mail®, and the like.

In exemplary embodiment, the agent 125 may include a calendar unification engine (CUE) 224 and a meeting generator 226. The agent 125 is configured to connect to multiple calendars stored in the repository 228 and generate an availability matrix. The agent 125 is further configured to standardize synchronizing to the scheduling server 130.

Specifically, in an embodiment, the CUE 224 connects to calendar repository 228 seamlessly to pull any information stored there. The seamless connection enables connectivity to all calendars stored in repository 228 without the need for any gateway or direct connectivity to the schedule servers 130.

The CUE 224 is further configured to combine information from all calendars stored in the repository 228 and determine the user availability based on the meetings scheduled in the calendars. In an embodiment, the combined availability information is saved in an availability matrix.

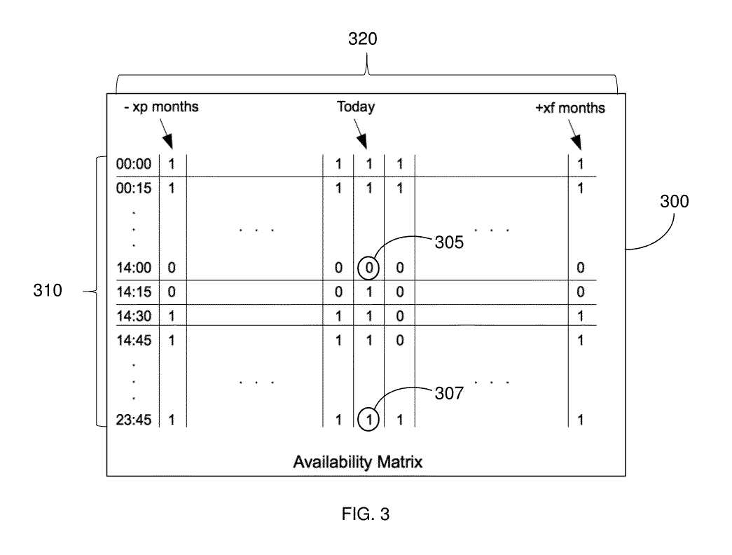

As shown in FIG. 3, the availability matrix 300 designates for each time slot (labeled as 310 in FIG. 3) during the day, during a predefined number of months (labeled as 320 in FIG. 3), if the user is available or not for a meeting. In a non-limiting embodiment, the matrix is a binary matrix (e.g., ‘0’ means that user is not available; while ‘1” means that the user is available). The predefined number of months may be related to past and future time.

As example, for a cell 305 (today at 14:00) the value is ‘0’, thus the user is unavailable; while for a cell 307 (today at 23:45) the value is ‘1’, thus the user is available. As the availability matrix 300 is generated from a combination of multiple calendars, it is enough that only one time slot will be designated as “unavailable” to mark “unavailability” in the matrix 300. On the other hand, a time slot in all calendars must be designated as “available” to mark “availability” in the matrix 300. Thus, the combination of operations to generate the availability matrix is a logical OR operation.

In an embodiment, the CUE 224 is configured to communicate with the scheduling server 130 to provide the generated availability matrix 300. In addition, any update in the availability matrix 300 is communicated to the server 130. For example, if the cell's value 305 changes from ‘0’ to ‘1’, the CUE 224 updates the matrix 300 and sends the updated matrix 300 to the server 130. It should be noted that data from the CUEs 224 of all participants are sent to the scheduling server 130. That is, CUEs 224-1 and 224-n generate availability matrixes 300 that are sent to the server 130.

In an embodiment, the meeting generator 226 is configured to initiate a scheduling of a new meeting or reschedule a meeting based on requests received from a user of the client device 120. As noted above, to schedule a new meeting, the meeting organizer (e.g., a user of one of the devices) simply needs to provide at least the requested participants and a duration of the meeting. The meeting generator 226 collects this information and sends the information to the server 130. In addition, the meeting generator 226 provides rescheduling requests to the server 130. Such a request may include the time of the scheduled meeting and preferably the meeting's participants. The meeting generator 226 may also receive, from the server 130, real time notifications to the user about acceptance and rejection of meetings, and display such notifications over the user interface 222.

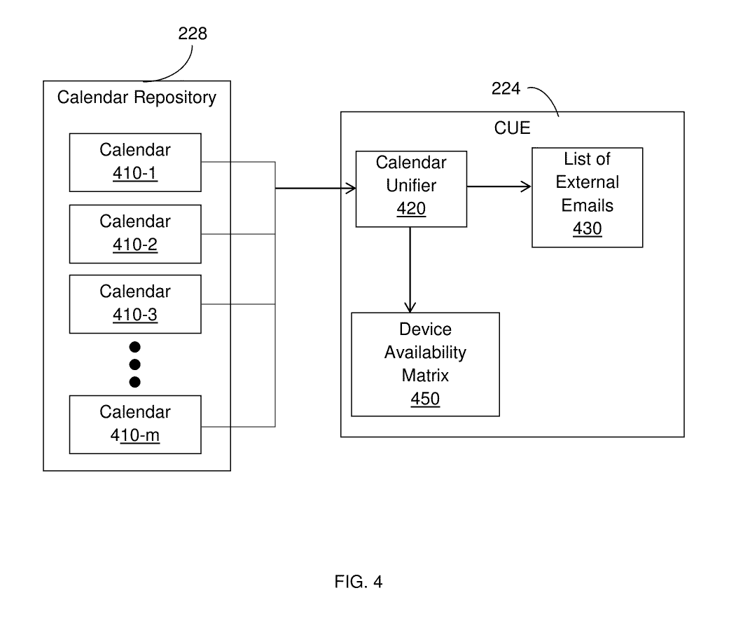

FIG. 4 is an exemplary and non-limiting schematic diagram depicting the CUE 224 in more detail. In an embodiment, the CUE 224 communicates with the calendar repository 228 which keeps a calendar 410 for each email account of the user. For example, the calendar 410-1 may be a Google calendar associated with Gmail® (email-1).

The CUE 224 includes a calendar unifier 420 which is configured in part to generate, using the calendars 410, the device availability matrix 450. In an embodiment, the calendar unifier 420 performs a logical OR calculation between time slots of the calendars 410. An exemplary availability matrix is shown in FIG. 3. The calendar unifier 420 is also configured to monitor changes in all calendars 410 and aggregate any changes. The aggregated changes are utilized to update the device availability matrix 450.

In an embodiment, the calendar unifier 420 identifies calendars associated with external emails 430 that are not active on any client device running the agent 125. The external emails 430 are sent and any meeting scheduled for such emails are sent to the server 130 to create a sub-availability matrix per such email.

In an embodiment, the modules of the agent 125 and server, such as those discussed above may be realized by a processing unit or system. The processing unit or system may comprise or be a component of a larger processing system implemented with one or more processors, examples of such processors are provided above.

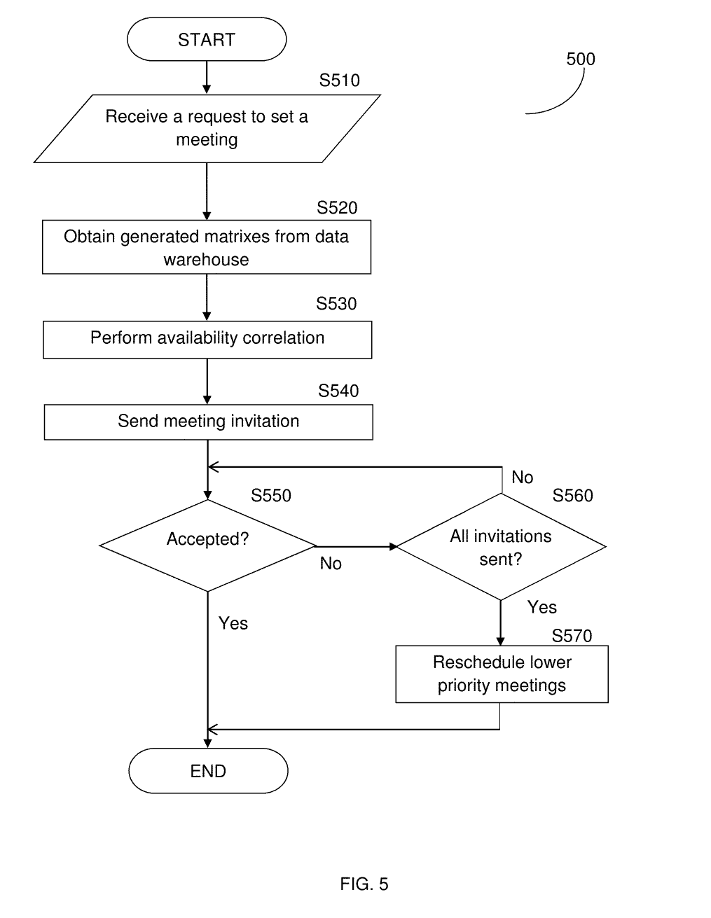

FIG. 5 is an exemplary and non-limiting flowchart 500 depicting a method for automatically setting a meeting among multiple participants according to one embodiment. At S510, a request is received to set a meeting. The request includes at least the requested participants (mandatory or optional), meeting duration, and optionally a suggested location. In an embodiment, the request is created by a meeting organizer.

At S520, the availability matrixes (AMs), sub-availability matrixes (SAMs), general behavior matrix (GBM), and aggregated behavior weight matrix (ABWM) generated for each of the participants, including the organizer, are obtained from the data warehouse 140. The generation of these matrixes is discussed in detail below.

At S530, an availability correlation process is performed to determine one or more available time slots for the meeting participants. The collaboration process takes into account the information included in the GAMs, SAMs, ABWMs, GBMs, and so on.

In an embodiment, S530 includes computing a score for each potential time slot based on the availability of the participants, the meeting duration, and at least one weighted availability factor set for the different participants. A predefined number (e.g., 3) of potential time slots with the highest scores are selected. Following is an example for computing a potential time slot score for two participants (designated by their email ‘i’ and ‘j’):

First, the availability of email i at time t is computed as follows:

$${GAM}_{email , i} = {\prod }_{r} {AM}_{{email}_{i} , {device}_{r}} , \cdot {\prod }_{s} {SAM}_{{email}_{i} , {device}_{s}} ,$$

where, GAM is a general availability matrix determined across all devices of a participant designated by email ‘i’. The GAM is sum of the availability as included in the respective AMs and SAMs.

Then, the weighted availability between the participants designated by emails ‘i’ and ‘j’ is computed as follows:

WeightedAvailability(emailᵢ,emailⱼ)=GAMₑₘₐᵢₗ_{ᵢ}+ABWM₍ₑₘₐᵢₗ_{ᵢ}_{,email}_{ⱼ}₎+GBMₑₘₐᵢₗ_{ᵢ}

where, GAM is the general availability matrix, ABWM is the aggregated behavior weight between the two participants, and GBM is the general behavior matrix for the participant designated by the email ‘i’.

Finally, the potential time slot score for a meeting between participants (email ‘i’ and ‘j’) at a time slot ‘t’ and a meeting duration ‘d’ is computed as follows:

$$PotentialTimeSlotScore = {\sum }_{{x}_{t} = t}^{t + d} {WeightedAvailability}_{{email}_{i} , {email}_{j , {x}_{t}}}$$

At S540, a meeting invitation is sent to the participants for a time slot having the highest score. Optionally, a check is performed for geographic conflict with closest adjacent calendar item locations prior to sending the invitation. At S550, it is checked if the participants accepted the meeting invitation, if so, execution ends. Otherwise, at S560, it is checked if all meeting invitations for time slots selected based on their score have been sent; if so, at S570, an error message is sent that the meeting cannot be scheduled; otherwise, execution returns to S540 where a new meeting invitation is sent. The new meeting invitation is a second highest score, a third highest score, and so on until reaching the number of predefined time slots.

It should be noted that the error message is sent to the meeting organizer. Such a message may include information regarding which of the participants cannot attend, suggested rescheduling dates and/or locations, and so on. Optionally, if no available time slots are determined, it is checked whether previously scheduled meetings can be rescheduled.

It should be noted that a scheduled meeting is used to update the availability matrixes of the meeting participants. An entry for the scheduled meeting is recorded in the data warehouse 140 and reminders can be sent to participants. Further, any note taken by the participants prior, during, or after the meeting is associated with the recorded entry.

The method discussed with reference to FIG. 5 can be performed by the scheduling server 130 or locally by an agent 125 installed on a client device 120 operated by a meeting organizer.

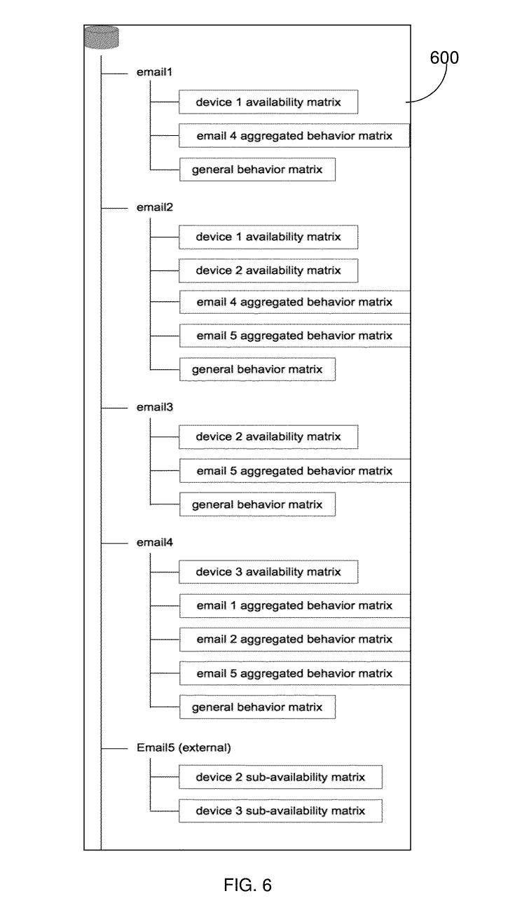

The GAM of a user is computed based on the availability matrixes received from all devices and emails associated with a user. To this end, the received availability matrixes are parsed, and for each email the availability is segmented per device. An exemplary diagram showing the segmentation is shown in FIG. 6.

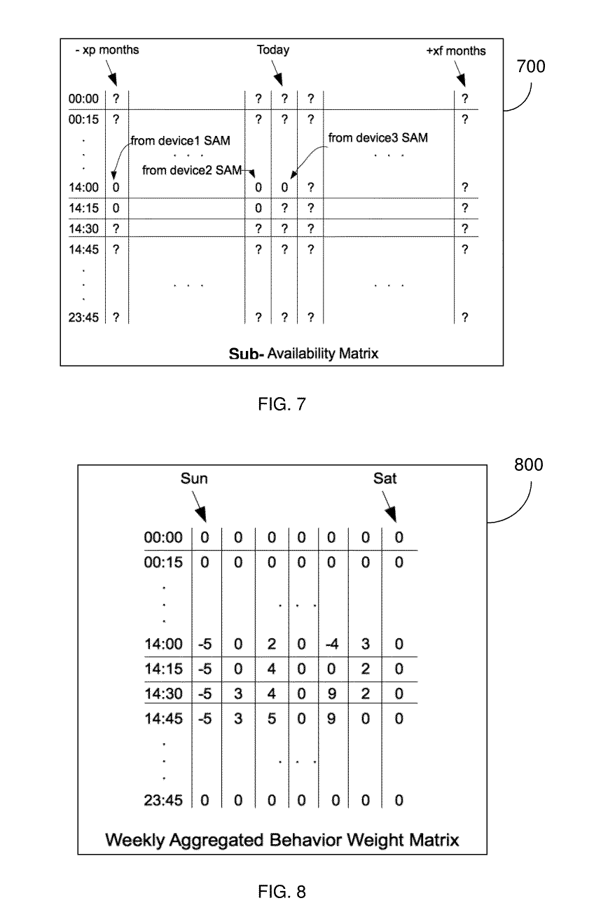

FIG. 7 is an exemplary and non-limiting diagram of a sub-availability matrix 700 computed to determine availability of a participant with an external email. Email accounts that are external to the server 130 are also monitored for partial availability by cross referencing meetings set for those email accounts on computing devices 120. The correlation results are stored in sub-availability matrixes 700 for this email account, per each computing device 120 with a related meeting set.

FIG. 8 is an exemplary and non-limiting diagram of a weekly ABWM 800 computed to determine availability of a participant. Past, future, and specific actions are used to create the weekly ABWM 800 of each email account (participant), per any other email account (participant). Actions which affect weights include, for example, setting a accepting a meeting, declining a meeting, rescheduling a meeting, and the like. In an embodiment, setting or accepting a meeting would positively affect the weight and declining or rescheduling a meeting would negatively affect the weight. In the embodiment illustrated in the FIG. 8, the ABWM 800 is generated for a week, however, this matrix can be generated for other time periods, such as bi-weekly.

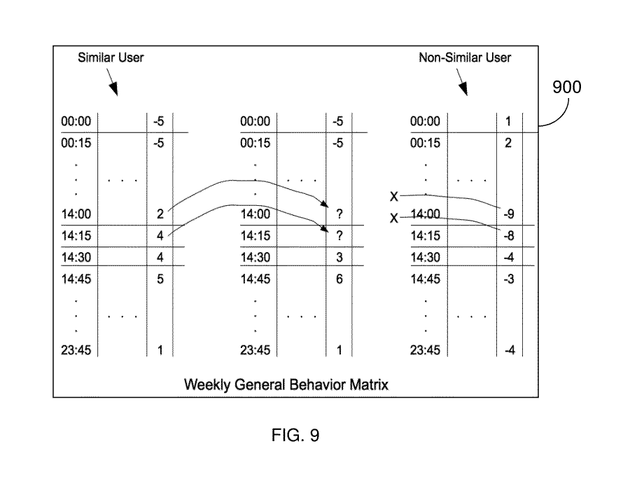

FIG. 9 is an exemplary and non-limiting diagram of a weekly GBM 900 computed to determine availability of a participant. The weekly GBM 900 is generated respective of known, learnt, or monitored behavioral patterns of the participant. For example, for users that do not work during the weekends, the weekly GBM 900 will designate the time slots in Saturday and Sunday as occupied. Various collaborative filter techniques can be utilized to generate the weekly GBM 900. In the embodiment illustrated in the FIG. 9, the GBM 900 is generated for a week, however, this matrix can be generated for other time periods, such as bi-weekly.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure. Furthermore, the foregoing detailed description has set forth a few of the many forms that the disclosed embodiments can take. It is intended that the foregoing detailed description be understood as an illustration of selected forms that the disclosure can take and not as a limitation to the definition of the disclosed embodiments.

What is claimed is:

1. A method for automatically setting a meeting among a plurality of participants, comprising:
receiving a request to set a meeting, wherein the request includes a list of the request participants and a duration of the meeting;
determining a global availability for each of the requested participants;
determining general behavioral availability for each of the requested participants and among the requested participants;
determining aggregated behavioral availability among the requested participants;
correlating the determined global availability, the aggregated behavioral availability, and the behavioral availability to result with at least one time slot having a higher acceptance probability; and
sending a meeting invitation for the at least one time slot.

2. The method of claim 1, wherein determining the global availability for each of the requested participants further comprises:
receiving, per a client device of a participant, at least one availability matrix including availability of the participant across all calendars associated with the participant;
receiving, per the client device of the participant, at least one sub-availability matrix including availability of the participant across all calendars not directly associated with the participant; and
aggregating the at least one availability matrix and the at least one sub-availability matrix across all client devices of the participant to result with a general availability matrix indicating the general availability.

3. The method of claim 1, wherein determining the general behavioral availability for each of the requested participants further comprises:
monitoring behavioral patterns of the participant with respect to the participant; and
applying one or more collaborative filters on the monitored behavioral patterns to result with a general behavior matrix (GBM) indicating the general behavioral availability.

4. The method of claim 3, wherein determining the aggregated behavioral availability among the requested participants further comprises:
monitoring secluding actions between a pair of participants during a predefined time period;
assigning a weight for each secluding action; and
computing an aggregated behavior weight matrix (ABWM) receptive of the assigned weights indicating the aggregated behavioral availability.

5. The method of claim 1, wherein resulting with at least one time slot having the higher acceptance probability further comprises:
computing a potential time slot score for the meeting based on the requested meeting duration, the determined global availability, and the aggregated behavioral availability; and
sending at least one meeting invitation with a predefined number of potential time slots having the highest score.

6. The method of claim 1, further comprising:
upon acceptance at the at least one meeting invitation by the requested participants, recording all notes taken by the requested participants; and
saving the notes in a data warehouse.

7. The method of claim 6, further comprising:
assigning an access control to saved notes.

8. The method of claim 7, further comprising:
providing a wizard to generate a meeting summary; and
sharing the meeting summary among the participant based on the assigned access control.

9. The method of claim 1, further comprising:
determining a location for the scheduled meeting respective of a physical location of each of the requested participant prior to a time slot of the scheduled meeting.

10. A non-transitory computer readable medium having stored thereon instructions for causing one or more processing units to execute the method according to claim 1.

11. A system for automatically setting a meeting among a plurality of participants, comprising:
a processing unit; and
a memory, the memory containing instructions that, when executed by the processing unit, configure the system to:
receive a request to set a meeting, wherein the request includes a list of the request participants and a duration of the meeting;
determine a global availability for each of the requested participants;
determine general behavioral availability for each of the requested participants and among the requested participants;
determine aggregated behavioral availability among the requested participants;
correlate the determined global availability, the aggregated behavioral availability, and the behavioral availability to result with at least one time slot having a higher acceptance probability; and
send a meeting invitation for the at least one time slot.

12. The system of claim 11, wherein the system is further configured to:
receive, per a client device of a participant, at least one availability matrix including availability of the participant across all calendars associated with the participant;
receive, per the client device of the participant, at least one sub-availability matrix including availability of the participant across all calendars not directly associated with the participant; and
aggregate the at least one availability matrix and the at least one sub-availability matrix across all client devices of the participant to result with a general availability matrix indicating the general availability.

13. The system of claim 11, the system is further configured to:
monitor behavioral patterns of the participant with respect to the participant; and
apply one or more collaborative filters on the monitored behavioral patterns to result with a general behavior matrix (GBM) indicating the general behavioral availability.

14. The system of claim 13, the system is further configured to:
monitor secluding actions between a pair of participants during a predefined time period;
assign a weight for each secluding action; and
compute an aggregated behavior weight matrix (ABWM) receptive of the assigned weights indicating the aggregated behavioral availability.

15. The system of claim 11, the system is further configured to:
compute a potential time slot score for the meeting based on the requested meeting duration, the determined global availability, and the aggregated behavioral availability; and
send at least one meeting invitation with a predefined number of potential time slots having the highest score.

16. The system of claim 11, the system is further configured to:
upon acceptance at the at least one meeting invitation by the requested participants, record all notes taken by the requested participants; and
save the notes in a data warehouse.

17. The system of claim 16, the system is further configured to:
assign an access control to saved notes.

18. The system of claim 17, the system is further configured to:
provide a wizard to generate a meeting summary; and
share the meeting summary among the participants based on the assigned access control.

19. The system of claim 11, the system is further configured to:
determine a location for the scheduled meeting respective of a physical location of each of the requested participants prior to a time slot of the scheduled meeting.
